(19) United States
(12) Patent Application Publication
(10) Pub. No.: US 2007/0192324 A1
(43) Pub. Date: Aug. 16, 2007

(54) Method and device for advanced cache management in a user agent

(75) Inventor: Geir Kenneth Pedersen, Oslo (NO)

Correspondence Address: BIRCH STEWART KOLASCH & BIRCH, PO BOX 747, FALLS CHURCH, VA, 22040-0747, US

(73) Assignee: OPERA SOFTWARE ASA, Oslo (NO)

(21) Appl. No.: 11/342,592

(22) Filed: Jan. 31, 2006

(51) Int. Cl. G06F 17/30

(52) U.S. Cl. 707/10

(57) ABSTRACT

According to principles consistent with the present invention, data may be designated for persistent storage in the cache of a client device, such that the persistently stored data is not subject to removal from the cache as a result of normal cache management. In response to executing a user agent, the client device may register one or more data files as being part of a persistent “service,” thereby causing the data files to be persistently stored. Such registration may be performed in response to the invocation of document object model (DOM)-based interfaces defined in the user agent. Also, the DOM-based interfaces may be called in order to change the persistent status of data files, or otherwise manage the registered services.

### BACKGROUND OF THE INVENTION

1. Field of the Invention

The present invention relates to advanced cache management for a user agent implemented on a client device, and in particular, to the management of data stored persistently in a cache memory that is otherwise configured to temporarily store data accessed from a server via a network connection. 2. Description of Background Art

In order to reduce bandwidth consumption and speed up content load-times when a user agent (e.g., web browser) accesses the same content repeatedly, most modern user agents are configured to store accessed content temporarily in local memory. This allows the user agents to load content that is requested repeatedly directly from the local memory, rather than downloading such content repeatedly from the network. This functionality is normally referred to as cache management, while the local memory (or portion thereof) allocated to store the content is referred to as a cache memory.

According to typical cache management schemes, if the same content is requested repeatedly, the user agent will find the requested content in its cache memory, and verify with the originating server that the version of the content found in memory is still valid or up-to-date. If the content is valid, the user agent loads the content from the cache memory rather than downloading it again. Accordingly, under such schemes, some communication with the server is still necessary. However, if the cached content is up to date, the only information transmitted over the network is identification of the version number and confirmation of the content's validity.

Data is normally stored in cache on a first-in, first-out basis, where old data is constantly being overwritten by new data accessed by the user agent. Accordingly, the life span of each piece of data in the cache is dependent on the amount of space, which is allocated to cache, in the local memory of the device in which the user agent is installed. To a certain extent, this first-in, first-out arrangement can be overridden by headers in the data files received by the user agent. For instance, such headers may specify that the data should not be cached. Alternatively, these headers may specify that the data should be cached, but expire after a certain time. Headers may also specify various rules for determining when and how the verification with the server should take place.

Rules on cache management may also be set in the user agent by specifying certain parameters of cache management, such as cache size and expiration time.

In these cache management schemes, however, there is no guarantee that data that has been installed in cache remains there. Content data may be replaced at any time by new content data, and there is no way to assure the continued presence of a particular set of data in cache.

A detailed description of caches and cache management is given in chapter 7 of HTTP: The Definitive Guide by David Gourley, Brian Totty and Marjorie Sayer, O'Reilley Media, Inc., September 2002, the contents of which is herein incorporated by reference in its entirety.

The term “user agent,” as it is used in the present specification, should be understood to include any software or software/hardware combination that implements at least the functionality necessary to connect to a communication network, request and receive data from servers or other resources connected to the network, and utilize the received data in some manner (e.g., by storing it, displaying it, playing it, or forwarding it to some other application also running on the client device). One exemplary type of user agent is a web browser (or specific modules thereof. However, for purposes of the present invention, the term is not limited to web browsers. Other types of user agents include, but are not limited to, search engines, web crawlers, and media players.

### BRIEF DESCRIPTION OF THE DRAWINGS

Exemplary embodiments of the present invention will become more fully understood from the detailed description given hereinbelow and the accompanying drawings. These drawings are given by way of illustration only and, thus, are not limiting on the present invention. In the drawings, like reference numbers represent like elements, wherein:

FIG. 1 illustrates an exemplary embodiment of a client device 100 that may be used as an environment for implementing various aspects of the present invention;

FIG. 2 is a block diagram illustrating various modules of a user agent, according to an exemplary embodiment of the present invention;

FIG. 3 is a block diagram illustrating a generalized architecture of a web server, according to an exemplary embodiment of the present invention;

FIG. 4 is flowchart of a process performed by a client device, according to an exemplary embodiment of the present invention; and

FIG. 5 is a data flow diagram in connection with a process whereby a user agent stores data persistently in a cache, according to an exemplary embodiment of the present invention.

### DETAILED DESCRIPTION OF EXEMPLARY EMBODIMENTS

The present invention is based on the realization that it would be advantageous to expand the functionality of the cache in a user agent in several ways. The present invention makes it possible to ensure the continued presence of certain designated data in a cache. This, in turn, makes it possible to install applications in the cache. This also allows for the pre-loading of content in order to achieve speedier access or to access the content at a time when the client device is not connected to the network.

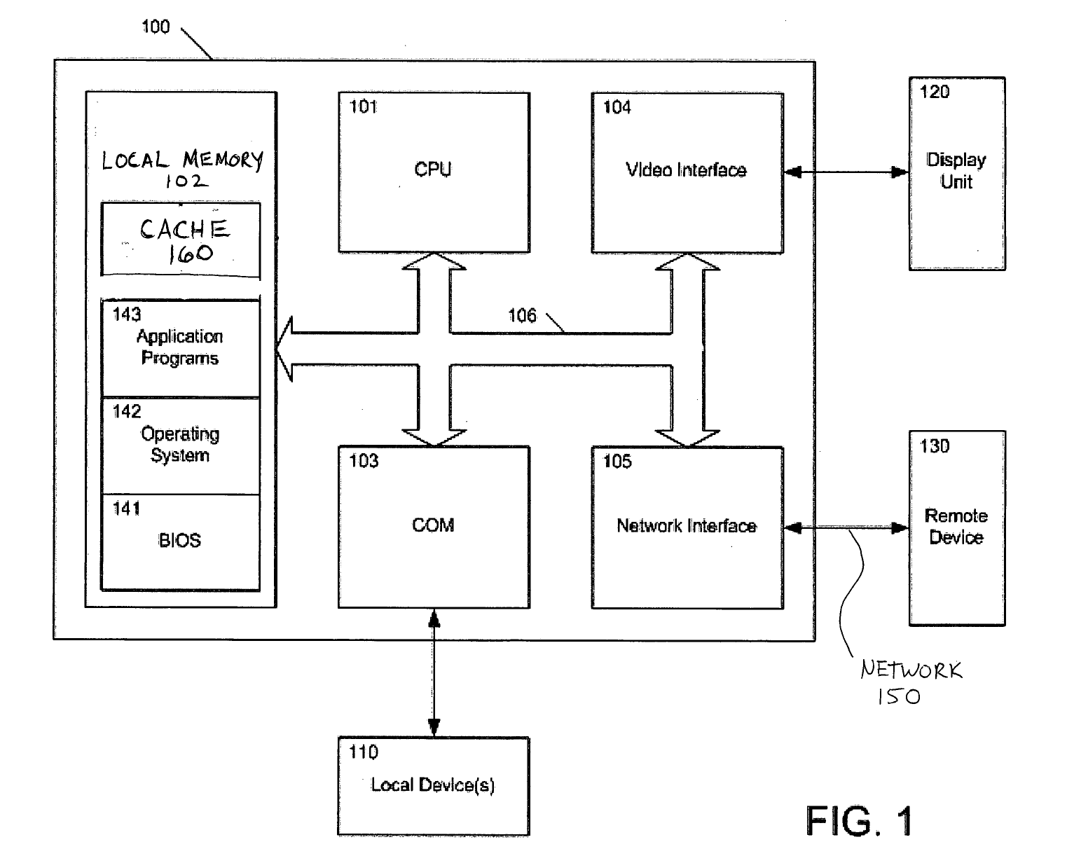

FIG. 1 illustrates an exemplary embodiment of a generalized client device 100 that may be used as an environment for implementing various aspects of the present invention. In FIG. 1, the client device 100 includes a central processor unit (CPU) 101, a local memory 102, one or more communication ports and/or input/output (I/O) ports 103, a video interface 104, and a network interface 105. These units are in communication with each other by way of a system bus 106.

Referring to FIG. 1, the local memory 102 may be comprised of one or more of the following types of memory devices: ROM, RAM, flash memory, and hard drives. Alternatively, the local memory 102 may comprise any other combination of fixed and removable memory devices. The local memory 102 generally stores the various software components of the device 100, which may include, but are not limited to, a basic input/output system (BIOS) 141, an operating system 142, various computer programs 143 including applications and device drivers, and various types of data (not shown), and other executable files or instructions such as macros and scripts (not shown).

As shown in FIG. 1, the local memory 102 also includes a cache 160. In an exemplary embodiment, the cache 160 is configured to hold data for a user agent, which (as described below) may be implemented as an application program 143 and/or part of the BIOS 141 or operating system 142.

The I/O ports 103 of FIG. 1 may be connected to one or more local devices 110 such as user input devices, a printer, a media player, external memory devices, and special purpose devices (e.g. a global positioning system receiver (GPS)). The I/O ports 103 may be any combination of USB, PS/2, RS-232, infrared (IR), Bluetooth, and printer ports, or any other standardized or dedicated communication interface for local devices.

As shown in FIG. 1, the video interface device 104 is connected to a display unit 120. The display unit 120 may be an external monitor or an integrated display, e.g., an LCD display. According to one exemplary embodiment, display unit 120 may have a touch sensitive screen, thereby allowing the display unit to also function as a user input device. The potential input device aspect of the display unit 120 may be considered as one of the local devices 110 communicating over a communication port 103.

The network interface device 105 provides the client device 100 with the ability to connect to a network 150 in order to communicate with a remote device 130. For instance, the communication network 150, which is illustrated in FIG. 1 as connecting the network interface 105 with the remote device 130, may be a local area network (LAN) or the Internet. However, the present invention is not thus limited, and may utilize any other type of network 150 or dedicated communication link between the client device 100 and remote device 130, as will be contemplated by those of ordinary skill in the art. As such, the remote device 130 may be any computing device with similar communications capabilities as the client device 100. However, in an exemplary embodiment, the remote device will typically be a server or some other unit providing a networked service.

It will be understood that the client device 100 illustrated in FIG. 1 is not limited to any particular configuration or embodiment regarding size or resources. Each component illustrated in the client device 100 may be implemented as one or more integrated units or distributed over several units in the client device 100. Other units or capabilities may, of course, also be present. Furthermore, the client device 100 may be a general-purpose computer such as a PC, a personal digital assistant (PDA), or even a cell phone or smart phone.

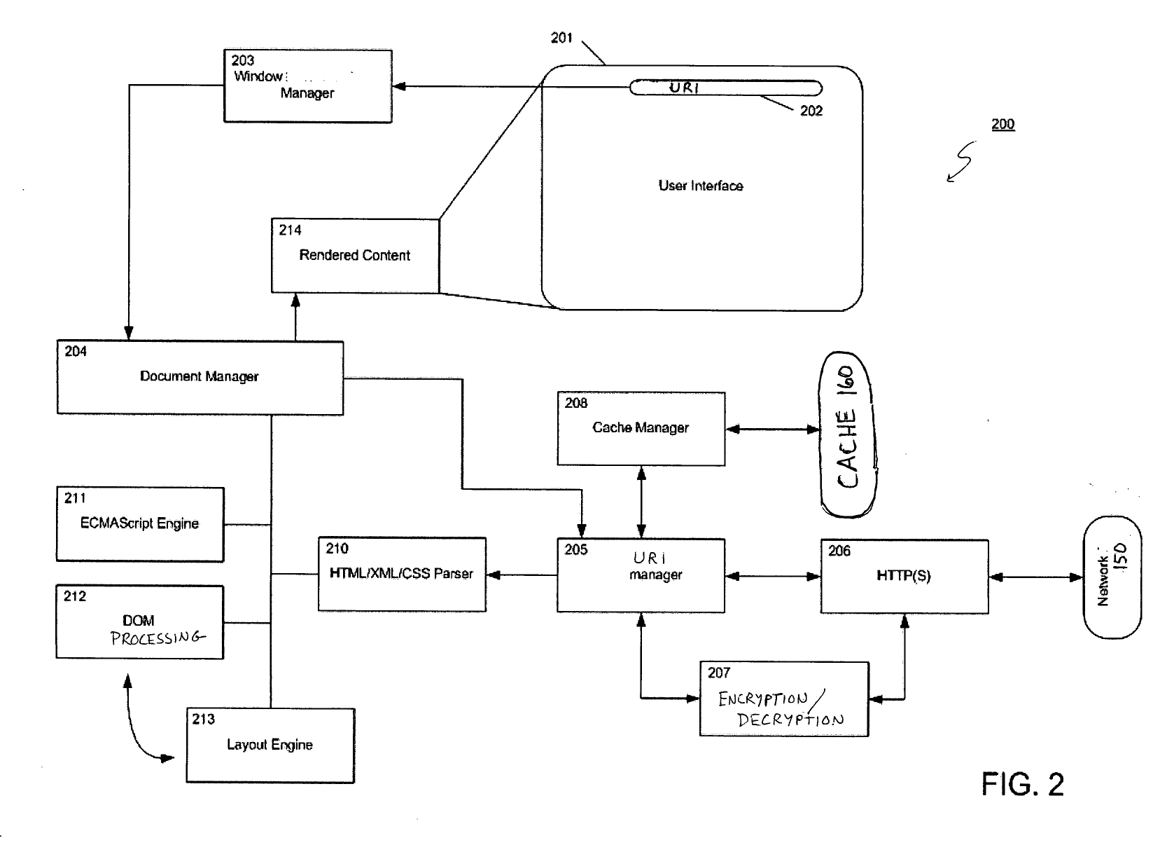

According to an exemplary embodiment, various aspects of the present invention may be implemented using the components and/or functionality of a user agent or browser, which is installed as an application in the client device 100. FIG. 2 illustrates modules that may be present in such a user agent 200. These modules will typically be software modules, or some other implementation of software, executed by the CPU 101 in the client device 100.

As shown in FIG. 2, user agent 200 may include a user interface 201 that may be displayed on the display unit 120 (shown in FIG. 1). The user interface 201 may include an address field 202, in which the user enters the uniform resource identifier (URI) of a document or a service to be retrieved by the user agent 200. The address field 202 may alternatively be a displayed hyperlink that may be activated by the user through the use of a pointing device (e.g., mouse), scrolling device, or some other means for selecting displayed items. Alternatively the URI may be specified in the code of a document or script already loaded by the user agent.

A URI is a formatted string that serves as an identifier for a resource. Traditionally, URIs are used for identifying resources—via name, location, or any other characteristic—on the Internet or Worldwide Web (WWW). In practice, URIs include uniform resource locators (URLs), relative URLs (RELURLs), and uniform resource names (URNs).

Referring again to FIG. 2, the URI entered by the user may be received by a window and input manager 203, which forwards the URI to a document manager 204. As will be described in more detail below, the document manager 204 is designed to manage the data received as part of the document identified by the URI.

In FIG. 2, the document manager 204 forwards the URI to a URI manager 205, which instructs a communication module 206 to request access to the identified resource. The communication module 206 may be capable of accessing and retrieving data from a remote device 130 (e.g., server) over a network using the hypertext transfer protocol (HTTP) or some other protocol such as hypertext transfer protocol secure (HTTPS) or file transfer protocol (FTP). The communication module 206 may also be capable of accessing data that is stored in local memory 102.

If it is necessary to encrypt communications outside the client device 100 (e.g., as specified by the protocol used for accessing the URI), the encryption/decryption module 207 in FIG. 2 may handle the communications between the URI manager 205 and the communication module 206.

Referring to FIG. 2, data received by the communication unit 206 in response to the request is forwarded to the URI manager 205. The URI manager 205 may then store a copy of the received content in local memory 102 using a cache manager 208. In particular, the cache manager 208 is responsible for performing the administrative functions with respect to the cache 160 residing in local memory 102.

Thus, if the URI associated with the received content is requested at a later time, the URI manager 205 may request a copy of the cached content from the cache manager 208. Thus, unless the cached copy has been deleted, the cache manager 208 will retrieve the data from the cache 160 and forward it to the URI manager 205. As such, it will not be necessary to retrieve this data again from the remote device 130 when the same URI is requested a second time.

Again referring to FIG. 2, the URI manager 205 may forward the received data to a parser 210, which is capable of parsing content encoded in, e.g., hypertext markup language (HTML), extensible markup language (XML), and cascading style sheets (CSS). Then, depending on the type and nature of the parsed content, the content may be further processed by an ECMAScript engine 211, a module for processing document object model (DOM) structures 212, and/or a layout engine 213.

The document manager 204 in FIG. 2 is responsible for administering the processing of the retrieved content. As such, the document manager 204 may forward additional URI requests to the URI manager 205 as a result of such processing. For example, these additional URIs may specify images or other files that should be embedded in the document specified by the original URI.

Referring to FIG. 2, after the content has been processed, the resulting data is forwarded from the document manager 204 to a rendering engine 214 in order to be rendered and displayed in the user interface 201.

According to an exemplary embodiment, the various modules thus described in connection with FIG. 2 are executed by the CPU 101 of FIG. 1, in response to instructions and data received over the system bus(es) 106. In such an embodiment, the communications module 206 communicates with the remote device 130 using the network interface 105.

It should be noted that FIG. 2 is provide for purposes of illustration, and that the functionality of any software-based module illustrated therein may be distributed or replicated over several modules. Conversely, the functions associated with two or more modules in FIG. 2 may be implemented using a single module, as will be contemplated by those of ordinary skill in the art.

It will further be understood that the some or all of the functionality of the user agent 200 described above may be implemented in an application program 143, the operating system 142 or BIOS 141 of the client device, or a combination thereof. Furthermore, the content received in response to a URI request may be embodied as data 144, a script 145, or a combination thereof (as will be further described below).

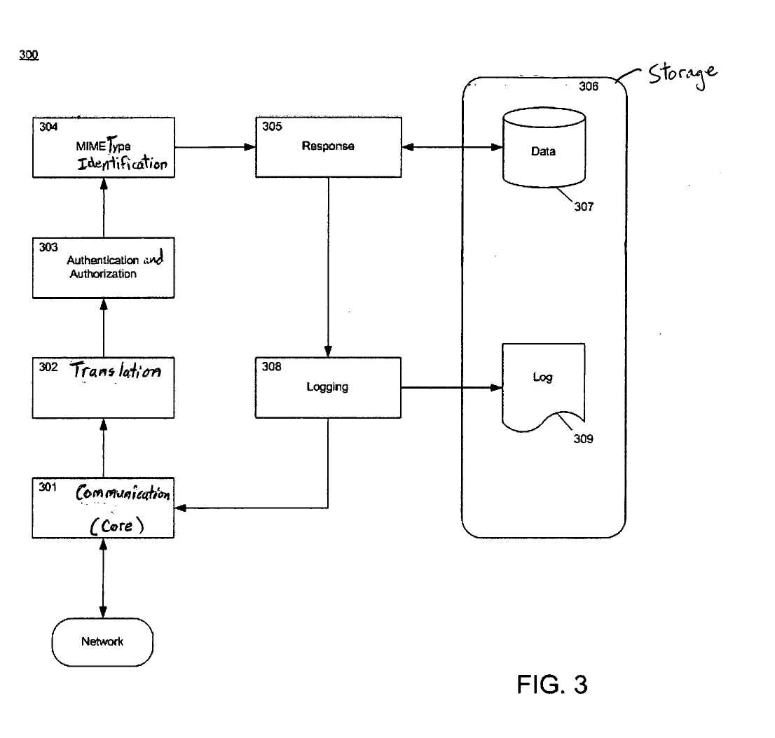

FIG. 3 illustrates a generalized architecture of a web server 300 that is consistent with aspects of the present invention. The illustrated modules primarily correspond with the architecture of the Apache web server, which is comprised of open-source software that runs on most commonly used platforms. Thus, the modules in FIG. 3 will typically be software-based modules running on hardware, as is well known in the art.

Referring to FIG. 3, a communication module 301 (in Apache referred to as the Core subsystem) receives requests from corresponding modules in web browsers, such as module 206 shown in FIG. 2. The communication module 301 continuously maintains a number of processes in order to be able to receive and respond to multiple requests received over the network. The communication module 301 stores information that is necessary to process requests (e.g., HTTP requests) and forward them to a translation module 302.

The translation module 302 in FIG. 3 determines the local location of a requested resource based on the URI received as part of the request. The authentication and authorization module 303 determines whether the requesting entity (e.g., user agent 200) needs to be authenticated, and whether the requesting entity is authorized to access the requested resource. Authentication and authorization may be performed by methods that are well known in the art, such as username/password.

As illustrated in FIG. 3, a MIME type identification module 304 is provided, which utilizes the multipurpose Internet mail extensions (MIME) standard to determine the type (or types) of resource(s) being requested. Thereafter the MIME type identification module 304 forwards the request to a response module 305.

Based on the identified local resource and MIME type, the response module 305 access and retrieves the resource from storage 306. The resource may comprise static or dynamic data 307. The resource may be stored in local storage 306, e.g., a file system or database that is local to the server system 300. Alternatively, the resource may be accessible from remote storage 306, e.g., from a remote server (not shown).

The response is generated by the response module 305 based on the retrieved data, and a logging module 308 records the request in a log file 309 in storage 306 before the response is forwarded to the communication module 301. The communication module 301 sends the response back to the requesting client (i.e., user agent 200).

It will be understood by those skilled in the art that the exemplary web server architecture described above in connection with FIG. 3 may be supplemented by additional modules. Also, it will be recognized by those skilled in the art how to configure the various modules illustrated in FIG. 3 in order to interact with an operating system and server hardware in a manner that is well known in the art.

According to an exemplary embodiment, data that is persistently stored in cache 160 in accordance with principles of the present invention will not be subject to removal from the cache 160 as a result of normal cache management by the user agent 200. In other words, persistently stored data will not be removed from the cache unless such data is explicitly deleted (e.g., by an express command of the user), or unless the status of the data as persistently stored is explicitly changed to a “non-persistent” status.

It will be understood by those skilled in the art that the terms “persistent” and “persistently” is not intended to imply anything beyond the principles delineated within this written description in connection with the various embodiments of the present invention. Accordingly, the use of these terms do not import any additional limitations regarding how long the data is stored, or to what extent the data's persistent status may be overridden by other functionality implemented in the user agent 200.

For instance, even if data is persistently cached according to embodiments of the invention defined herein, it may still be possible to delete such data along with the rest of the data in the cache 160 by invoking a method or functionality in the user agent for freeing the entire cache 160. However, whether persistently stored data should be protected from such deletion is a matter of design choice.

According to an exemplary embodiment of the invention, both the persistent cache (described in further detail below) and normal cache may be allocated to the same physical area of local memory 102 within the client device 100. However, the present invention is not limited to such an embodiment. For example, in an alternative embodiment, the persistent and normal caches, respectively, may be allocated to separate memory areas within the same physical memory device or unit. Alternatively, the persistent cache and normal cache, respectively, could be allocated to separate physical devices or units of memory.

However, in the description of exemplary embodiments that follows, lower level memory management issues like memory allocation and capacity will not be discussed in detail. Thus, for purposes of convenience, both persistently stored data and other data in cache will be described hereinbelow as sharing the same area in local memory 102, even though this does not have to be the case.

Any type of data may be stored persistently in cache 160 in accordance with the present invention. Thus, persistently stored data may represent executable code (e.g., web application), data representing media and/or other types of content. Also, such data may be of a type that can be accessed directly by the user agent 200, or indirectly by some other application or device capable of interacting with the user agent 200. Persistently stored data may include a single file, or a collection of files that are somehow related to or associated with each other.

According to an exemplary embodiment, data stored persistently within the cache 160 is organized into “services.” For purposes of this invention, a service is defined as a set of associated data stored persistently, whether it includes only one file or several files. A service may include: passive content, interactive content, executable code, or a combination thereof. It will be understood that, as a design choice, it is within the scope of the invention to introduce limitations to the type of data that may be stored persistently in cache as will be contemplated by those of ordinary skill in the art.

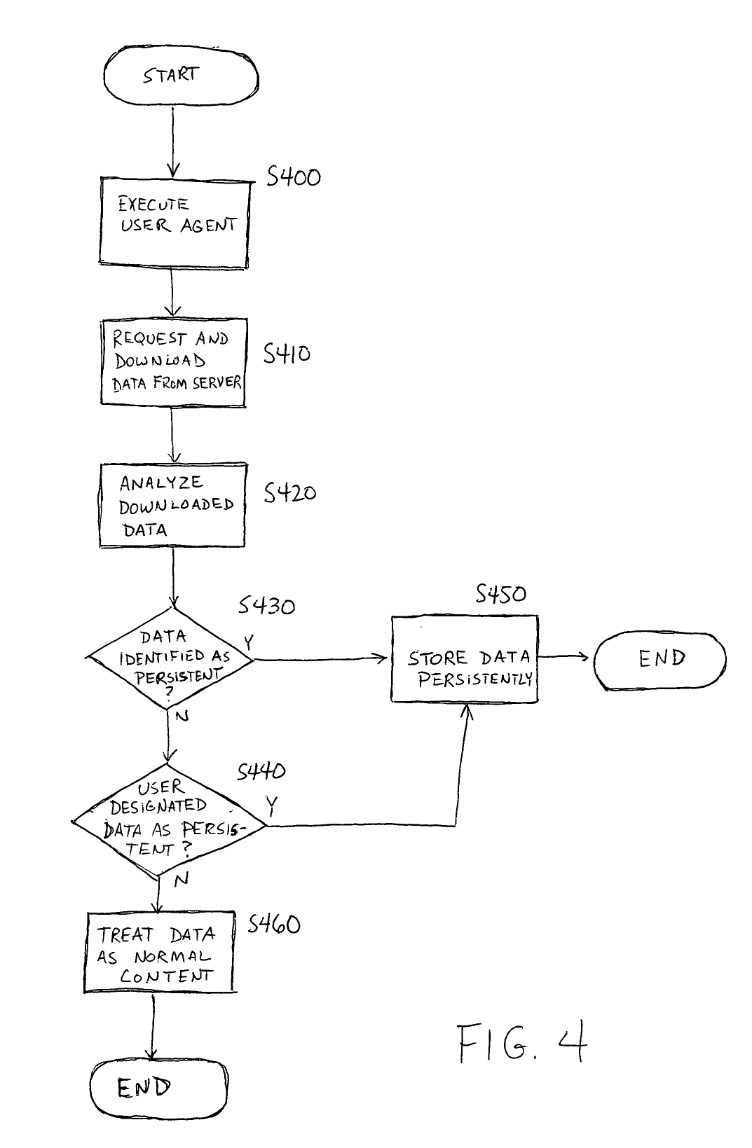

Reference is now made to FIG. 4, which is flowchart illustrating a process performed by a client device 100 according to an exemplary embodiment. As illustrated in FIG. 4, a user agent program 200, such as a browser, is executed (S400). As described above in connection with FIG. 1, the client device 100 is connected to a communications network 150, such as the Internet. Using the network 150, data is requested and downloaded from a web server, or other remote device 130, as illustrated in S410. This data may include a number of files, including markup language documents, graphics files, audio files, etc. Such files, if they are to be stored persistently, may be stored as part of the same service.

As illustrated in S420, when the requested data is received by the user agent 200, it should be analyzed in order to determine whether it is to be stored persistently as a service. According to an exemplary embodiment of the present invention, the received data may have a mechanism for identifying itself a service (or part thereof) to be stored persistently, as shown in S430. For example, the received data may be identified as persistent through a script that is part of the received data (as will be described in further detail below). Other alternatives may include using one or more headers in at least one of the received files, to specify that the data is to be cached as a persistent service.

However, other aspects of the invention may allow the user to invoke functionality in the user agent 200 that designates the received data to be stored as a persistent service, even without any explicit definition of the service as such internally to the service. This is illustrated in S440 of FIG. 4.

As shown in FIG. 4, if the downloaded data identifies itself as being a persistent service (or part thereof (Y in S430), or if the user designates the downloaded data as persistent (Y in S440), the client device 100 will treat the data as a service to be stored persistently in the cache as shown in S450.

In the embodiment illustrated in FIG. 4, both of the above-described mechanisms for specifying the data as persistent may be used in tandem. In other words, the user agent 200 may be configured to detect a persistent service using both a mechanism (e.g., script or headers) within the data itself (S430), and a mechanism based on a user designation (S440). However, in alternative embodiments, the user agent 200 may be designed to only rely on one of these mechanisms.

It will be understood that in the case where the data identifies itself as persistent (S430), the source (e.g., author or creator) of the data is responsible for designating the service as persistent. Alternatively, in the case where a user manually invokes functionality of the user agent 200 to store the service persistently in cache 106, the user of the client device 100 is responsible for designating the service as persistent. However, it should be noted that in either case, it is possible to demand a confirmation or acceptance by the user of the client device 100 before any service is stored persistently.

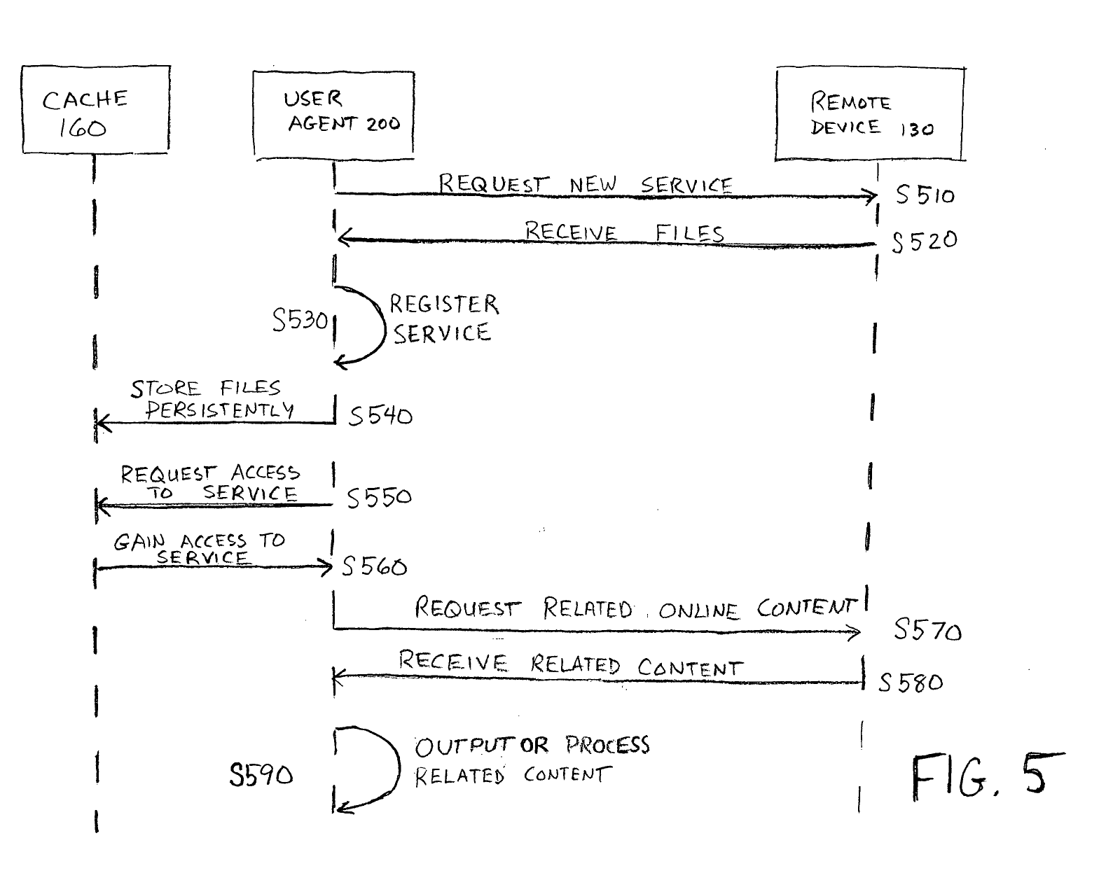

FIG. 5 is a data flow diagram in connection with a process whereby a user agent 200 may access and store data persistently in the cache 160, according to an exemplary embodiment. It will be understood that FIG. 5 is merely exemplary of such a process and that, to a certain extent, the data operations illustrated therein may overlap or have a different sequence. It would also be possible to register a service as being persistently stored before storing the files belonging to that service, or the files could be stored first and then registered as belonging to the same service. Yet another alternative is to register the service even before any part of the service has been requested and received, and then proceed to request the service from a server.

Consequently, the sequence of operations described below in connection with FIG. 5 should not be interpreted as mandatory. In principle, these operations could be performed in any sequence. However, there are some obvious exceptions. For instance, the user agent 200 cannot perform certain operations on data unless that data is actually present in the client device 100. E.g., a request has to precede the receipt of the requested data. Also, data must be received before it can be stored in the cache 160, and the data must be stored in the cache 160 before the user agent 200 can access the data from the cache 160. Keeping this in mind, an exemplary sequence of steps will now be described.

In S510, the user agent 200 requests a new service from a remote device 130. In an exemplary embodiment, the remote device 130 may be a server that receives and processes the request in a manner similar to that described above in connection with FIG. 3. In response to the request, the server 130 transmits the service to the user agent 200 as shown in S520. It should be noted that S510 and S520 actually may include a sequence of requests and responses, e.g., as a result of the first requested file including references to additional files that are also part of the service. For the sake of convenience, a service request (S510) is intended to include any such recursive sequence of requests.

Referring to FIG. 5, after the user agent 200 has received the service, and determined that the service should be stored persistently, the user agent 200 registers the service as being persistent in S530. Such registration may be the result of a method call within a script executed by the user agent 200, or the result of an installation request from the user, as will be further described below.

S540 of FIG. 5 shows that the data representing the service is stored in cache memory. Although S540 illustrates the storing of the data as one operation, it is not necessary for all the data files associated with the service to be stored at the same time. For instance, it would be possible to receive one part of a service and store this part persistently before another part of the same service is received and stored. Furthermore, while the stored data may comprise one or more data files, it will be understood that this data may also include parameters that are entered into files by the user agent 200 (e.g., variables that are already present in the local memory 102, or data input by the user of the client device 100). Also, as described above, the step of storing the service in cache memory 160 (S540) may precede the registration of the service (S530).

As a result of S540, the service is now stored persistently. According to an exemplary embodiment, such data will not be removed from cache 160 unless it is explicitly deleted, or unless the status of the data as persistently stored is explicitly changed.

Referring again to FIG. 5, if the user agent 200 again needs access to the service (S550), the service will now be requested from the cache memory 160 (S550) and accessed from cache memory 160 (S560), similar to any other content stored in cache 160. The accessed content may now be displayed or output to the user, or processed in any appropriate manner, as illustrated in S590.

As shown in FIG. 5, it may be the case that the persistently cached data is to be used in conjunction with other online content requiring frequent updates. In such a case, the user agent 200 may transmit another request to the server 130 for the online content in S570, and receive the requested online content in S580. An example of this is where the persistently stored service contains executable files for a web application for displaying up-to-date news stories, weather reports, etc.

The actual installation of a service as one persistently stored in cache memory 160 will now be described in further detail.

As described above, a persistently stored service may be installed as a result of the execution of a script or at the request of a user. In any case, the actual installation may be performed by executing native code routines and/or functions in the user agent 200. As such, script methods and user calls represent different ways of calling these native code instructions.

Thus, according to an exemplary embodiment of the present invention, a number of routines and/or functions may be implemented as part of the user agent 200. These routines and functions may be declared as methods, such methods being provided as part of one or more document object model (DOM) interfaces implemented in the user agent 200.

There are alternative approaches for installing persistently stored services within the user agent 200. These alternative approaches include the use of external or internal scripts, or the user-invoked installation. Any of these alternative approaches may be used in conjunction with the implementation of DOM interfaces.

According to the external script approach, the user agent 200 may execute an external script that includes all the necessary commands for installing the service. According to this approach, the downloaded data file containing the script is not itself registered as part of the service (the document, however, may be part of a different service). However, it is not absolutely necessary for the user agent 200 to execute the external script. For instance, the external script could be executed by a different program (or even a different device), which issues commands to the user agent 200 to register the service.

Another alternative is the use of internal scripts. This differs from the external script approach in that the script, which issues the commands for registering the service, is a data file to be associated with that service. When using an internal script, the script may begin with commands for checking whether the service is already installed, thereby avoiding duplicate registration of the same service.

A third alternative is for a service to be installed by a user of the client device 100. For example, an installation routine may allow the user to designate a web document by its URI for registration as a service. In response, the routine could register the designated document, and any files or objects that are directly loaded as a result of inline references in the designated document (image files, other documents loaded by object or iframe tag, etc.), as being part of the service. It is further contemplated that, in addition to documents referenced by the designated document, documents referenced by the referenced documents (up to a certain pre defined level) could also be installed.

It should further be noted that any combination of external script, internal script, or user-invoked installation may be employed for the same user agent 200 without departing from the scope of the present invention.

The use of DOM interface methods to install documents persistently in cache 160 has its advantages. Particularly, DOM-defined methods can take advantage of the security policy already implemented in most user agents or web browsers. For example, the cross-domain restriction on the exchange of event messages helps prevents certain types of script attacks. In view of these advantages, a more detailed description of exemplary methods, which may be implemented in the user agent 200 by one or more DOM interfaces, is provided below.

newService(URI)

This method registers a service, using a “URI” to define the service uniquely. This URI is not loaded, and does not have to represent any actual resource on the network (although it may). Instead, this URI serves as a reference to the particular service. According to an exemplary embodiment, the user agent 200 maintains a one-to-one relationship between each URI and registered service. Thus, as long as the URI referenced in a call to newService has not already been used to register another service, and has a valid URI format, the URI may be accepted by the user agent 200; otherwise the user agent will return an error message. However, as a matter of design choice it is possible to impose additional restrictions on the URI parameter, such that certain URIs are not accepted.

Also, in an exemplary embodiment, the user agent 200 may internally replace the referenced URI with a serial number for the service. According to such an embodiment, the serial number assigned by the user agent 200 to each registered service may be unique and never reused for other services. However, in an alternative embodiment, serial numbers may be reused, e.g., after the corresponding services have been explicitly deleted from the cache 160.

freeService(serviceRef)

This method basically has the opposite purpose of the newService method described above. Using the service serial number (serviceRef) described above as input, the freeService method is used for deleting the registration of a particular service. According to an exemplary embodiment, a call to the freeService method may have the effect of formally eliminating a service, while the actual data associated with the service may be retained in local memory 102 as normally cached data, and thus handled by traditional cache management methods. However, in an alternative embodiment, the freeService method may have the effect of deleting the data associated with the service, thereby freeing the corresponding memory space within the cache 160. As a matter of design choice, either of these alternatives may be implemented, or both alternatives may be implemented by the user agent 200 through different methods. It is further contemplated that both alternatives may be implemented by the same method through the use of additional input parameters.

The freeService method may also be implemented to accept a URI as the input argument serviceRef, instead of the serial number. The user agent may then check to see if a service identified by that particular URI has been previously registered. If this is the case, that particular service will be removed, as described above.

According to an exemplary embodiment, the various services may be referenced as an array,
services[].

If the services are assigned serial numbers sequentially, and if serial numbers are reused, the serial numbers may be the index in the services array. Alternatively, it may be desirable to keep all serial numbers unique, and in this case only the array index numbers may be reused. An up-to-date record of which serial numbers correspond with which array index may then be maintained at all times.

The array approach makes it particularly easy to access individual services and, if desired, make changes to a registered service. It may also make it very easy to find the URI of a registered service. Each entry in the array may be an object, which represents or references the particular service. This object may include certain information relating to that service, and functions or methods that may be accessed in order to perform actions on the service, as will be described in more detail below.

For each service, the following fields represent useful aspects of the invention, and may be realized as attributes of each services object. The invention may be implemented without the implementation of all these fields.

TABLE 1

| Field | Description of Field | |
|---|---|---|
| uri | the URI for the service | |
| serial number | serial number for service | |
| documents | number of documents | |
| expiry | expiry time | |
| whenLoaded | time when this service was last read from the | |
| | originating server, or verified to be current | |
| lastModified | time when the service, or any document | |
| | belonging to the service, was last modified | |
| newVersionAvailable | integer with the following possible values: | |
| | 0 | no new version is available |
| | 1 | currently checking if a new version is |
| | | available |
| | 2 | new version is available |
| reloadStatus | Integer with the following possible values: | |
| | 0 | no reload activity ongoing |
| | 1 | queued for reload |
| | 2 | reload in progress |
| | 3 | reload failed - network error |
| | 4 | reload failed - out of cache memory |

A description is provided below of exemplary methods or functions that may be implemented by the services objects. As such, the following description will make reference to “documents” that are associated (or is to be associated) with a particular service. For purposes of the following descriptions, use of the term “document” is meant to be inclusive of any type of document, script, or file (executable or otherwise) to be associated with a particular service and stored persistently in the cache 160.

services [].newDocument(URI)

The method newDocument adds a document to a service. The service to which the document should be added may be referenced, as shown above, as an object in the services array. Thus, if each service is represented as an object in a DOM tree, newDocument may be a method belonging to the services object. Various advantages of this approach will be described below. In an alternative embodiment where implementation is not object oriented, an identifier of the actual service may be used as another input argument to the newDocument method, in addition to the URI argument.

For the newDocument method, the URI argument may be the actual URI of the document that is added to the service. As such, registration by the call to newDocument may cause the document to be downloaded by the user agent 200 via network 150, and stored in cache 160. However, the document does not have to be downloaded as a result of the method call if that document already exists in the cache 160. An example of this is where the referenced document was previously loaded to be displayed (or otherwise used) by the user agent 200. Thereafter, the newDocument method may be called so that the document will reside in cache memory 160 persistently. In this case, the instance of the document that is already present in memory may be retained, and the URI that is registered by the newDocument call will refer to this instantiation in memory.

The URI argument of the newDocument method may even refer to a document that is already registered with respect to another persistent service. In general, it is possible for several registered services to reference the same document. According to an exemplary embodiment, these services will all reference the same instantiation of the documents in cache 160. In other words, documents do not have to be replicated in memory just because they are being registered as part of a persistent service.

services[].freeDocument(documentRef)

This method basically has the opposite purpose of the newDocument method.

The freeDocument method removes a particular document from a service. After this method has been invoked, the service remains as a registered service, and any other data files or documents belonging to the service also remain. It only affects the document identified in the input argument (documentRef) of the method. The input argument may be the document serial number. Alternatively, the document may be referenced through its URI.

documents[]

Each document added to a service may receive a serial number that is unique to the document. As such, the user agent 200 may maintain a one-to-one relationship between each URI for a registered document and each document serial number. According to an exemplary embodiment of the invention, it is possible that each serial number need only be unique with respect to the documents belonging to a given service. In such an embodiment, the documents may be registered in an array,
documents[]
   that belongs to a service object, and the document serial number may serve as an index for the documents array. However, according to an alternative embodiment of the invention, documents may be a global array, and the document serial numbers are globally unique. Whether serial numbers should be reused or not is, as with the services array, a question of design choice and may depend on the particular needs and preferences of the designer.

For example, it might be desirable not to reuse serial numbers in situations where it is anticipated that a different services will interact with each other or each other's documents. Similarly, if it is anticipated that external programs or devices will interact with the user agent's 200 registered services, it might be desirable not to reuse serial number. For security reasons, it might be desirable not to reuse serial numbers to make sure that a particular service does not interact with a wrong service or document, which is using an outdated serial number.

Each entry in the array documents array may be an object that represents or references the particular document. Each of these objects may include certain information relating to the corresponding document, and functions or methods that may be accessed in order to perform actions on the document.

The examples described further hereinbelow are based on an embodiment in which the documents array belongs to a service object in a services array. According to this embodiment, a particular document may be referenced as
services[].documents[].

Information about documents that are part of a service may be available through the documents array available for each service. For each document the following fields represent useful aspects of the invention, that may, but do not have to, be implemented.

TABLE 2

| Field | Description of Field | |
|---|---|---|
| uri | the URI for the document | |
| serial number | serial number for the document | |
| size | size in bytes | |
| expiry | expiry time | |
| whenLoaded | time at which this document was last read from | |
| | the originating server, or verified to be | |
| | current | |
| lastModified | value from the last-modified http header | |
| newVersionAvailable | integer with the following possible values: | |
| | 0 | no new version is available |
| | 1 | currently checking if a new version is |
| | | available |
| | 2 | new version is available |
| reloadStatus | Integer with the following possible values: | |
| | 0 | no reload activity ongoing |
| | 1 | queued for reload |
| | 2 | reload in progress |
| | 3 | reload failed - network error |
| | 4 | reload failed - out of cache memory |

The next method to be described serves a purpose, which is generally opposite to that of the newDocument method.

services[].documents[].checkForNewVersion()

According to traditional cache management, the cache manager 208 will, compare the version of a document stored in cache 160 with the version on the server it was downloaded from before using the version in cache. According to an exemplary embodiment of the present invention, the checkForNewVersion method may be provided for this purpose.

When this method is invoked, the user agent 200 sends a request to the originating server or remote device 130 to check if a new version of the document is available. This check may be performed asynchronously. In an exemplary embodiment, when checkForNewVersion is invoked, the cache manager 208 sends a HTTP HEAD request to the remote device 130 in order to check the last modified time, or other cache control headers. No update of the particular document itself results from invoking this method, but a “newVersionAvailable” status variable in the document object may be changed.

services[].documents[].reload()

The reload method may be called to reload the corresponding document from the originating server or remote device 130. The document may be reloaded asynchronously, and status information on the reload may be posted in the reloadStatus variable described above.

Continuing with the object oriented and DOM based example discussed above, the checkForNewVersion and reload methods described above may belong to the document object. As such, neither checkForNewVersion nor reload would require any input argument identifying the particular document in question, since both methods would be called on a particular document in a particular service. Alternative implementations are, however, possible, and according to some implementations it may be necessary to specify the document as an input argument to the method.

Although various exemplary embodiments have been described above, the present invention is not thus limited.

For instance, while the above description discusses the use of object oriented methods within the user agent 200, the same functionality may be implemented in a non-object oriented manner.

Similarly, the above written description describes attributes as being stored in the services and documents arrays. However, it is contemplated that one or more of these attributes may be stored in tables external to these arrays.

What is claimed is:

1. A client device, which is connected to a server via a network link, the client device being configured to execute a user agent in order to:
send a request to the server for at least one data file;
receive the at least one data file from the server in response to the request;
register the at least one data file as being associated with a service; and
persistently store each data file associated with the service in a cache.

2. The client device according to claim 1, wherein executing the user agent further causes the client device to:
receive a plurality of data files in response to the request, at least one of which includes commands, and
identify and register the at least one data file as a result of executing the commands.

3. The client device according to claim 2, wherein
the executed user agent comprises a web browser program executed on a computer readable medium in the client device, and
the plurality of data files include a script containing the commands to be executed in accordance with the executed user agent.

4. The client device according to claim 3, wherein the request is an HTTP or HTTPS request.

5. The client device according to claim 1, wherein the executing the user agent further causes the client device to register the at least one data file as being associated with a new service.

6. The client device according to claim 1, wherein executing the user agent further causes the client device to register the received one or more data files as being associated with an existing service, which is already associated with another persistently stored data file.

7. The user agent according to claim 1, wherein executing the user agent further causes the client device to:
allow the user to designate the at least one data file for persistent storage, thereby causing the client device to register the at least one data file as being associated with the service.

8. The client device according to claim 1, wherein executing the user agent further causes the client device to:
allow a user to modify the at least one data file by entering a parameter; and
register the modified at least one data file as being associated with the service.

9. The client device according to claim 1, wherein executing the user agent further causes the client device to:
access a persistently stored data file, which is associated with the service, from the cache;
request and receive content from the server in relation to the accessed data file; and
execute the data file in order to output or process the content.

10. The client device according to claim 1, wherein executing the user agent further causes the client device to call a plurality of methods for managing data files that are persistently stored in the cache.

11. The client device according to claim 10, wherein the executed user agent includes one or more Document Object Model (DOM) interfaces, which define the plurality of methods.

12. The client device according to claim 11, wherein the one or more DOM interfaces define:
a new service method for registering a new service for persistent storage in the cache; and
a new document method for registering a data file as being associated with a registered service.

13. The client device according to claim 11, wherein the one or more DOM interfaces define a free service method for deleting the registration of a service from the cache.

14. The client device according to claim 13, wherein a call to the free service method further causes all data files associated exclusively with that service to be deleted from the cache.

15. The client device according to claim 11, wherein executing the user agent further causes the client device to refer to a data file according to a Uniform Resource Identifier (URI) when calling one of the methods.

16. The client device according to claim 11, wherein executing the user agent further causes the client device to assign a unique identifier to each data file registered for persistent storage, and use the unique identifier to refer to data files when calling one of the methods.

17. The client device according to claim 1 wherein the at least one data file is persistently stored in the cache until at least one of the following occur:
a method is invoked for deleting or reloading the at least one data file, and
an expiry time defined in accordance with the at least one data file or the associated service expires.

18. A method performed in a client device, the client device being connected to a server via a network link, the method comprising:
sending a request to the server for at least one data file;
receiving the at least one data file from the server in response to the request;
registering the at least one data file as being associated with a service; and
persistently storing each data file associated with the service in a cache.

19. A computer program product including computer instructions for performing the method of claim 18, and a computer readable medium on which the computer instructions are stored.
